(19) United States
(12) Patent Application Publication
(10) Pub. No.: US 2010/0039919 A1
(43) Pub. Date: Feb. 18, 2010

(54) Cantilever Structure for Use in Seek-and-Scan Probe Storage

(75) Inventors: Tsung-Kuan Allen Chou, San Jose, CA (US); David Harrar, II, Sunnyvale, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/207,980

(22) Filed: Sep. 10, 2008

Related U.S. Application Data
(60) Provisional application No. 61/089,284, filed on Aug. 15, 2008.

(51) Int. Cl. G11B 9/00

(52) U.S. Cl. 369/126; G9B/9

(57) ABSTRACT

An information storage device comprises a media including a ferroelectric layer formed over a conductive layer, a tip substrate including a bottom actuation electrode, the tip substrate arranged opposite the media, and a cantilever connected with the tip substrate at a fulcrum and actuatable toward the media. The cantilever includes a first portion and a second portion, with the fulcrum located between the first portion and the second portion. The first portion is conductive and arranged over the bottom actuation electrode while a top actuation electrode is associated with the second portion so that the top actuation electrode is opposite the media. A first potential is applied to the bottom actuation electrode to generate electrostatic force between the bottom actuation electrode and the first portion and a second potential is applied to the top actuation electrode to generate electrostatic force between the top actuation electrode and the conductive layer. The cantilever rotates when the first potential and the second potential are applied so that the tip contacts the media.

### CLAIM OF PRIORITY

This application claims benefit to the following U.S. Provisional Patent Application:

U.S. Provisional Patent Application No. 61/089,284 entitled “CANTILEVER STRUCTURE FOR USE IN SEEK-AND-SCAN PROBE STORAGE”, by Chou et al., filed Aug. 15, 2008, Attorney Docket No. NANO-01113US0.

### CROSS-REFERENCE TO RELATED PATENT APPLICATIONS

This application incorporates by reference the following co-pending application:

U.S. Provisional Patent Application No. 61/089,276, entitled “METHOD AND DEVICE FOR DETECTING FERROELECTRIC POLARIZATION,” by Adams, filed Aug. 15, 2008, Attorney Docket No. NANO-01104US0.

### BACKGROUND

Software developers continue to develop steadily more data intensive products, such as ever-more sophisticated, and graphic intensive applications and operating systems. As a result, higher capacity memory, both volatile and non-volatile, has been in persistent demand. Added to this demand is the need for capacity for storing data and media files, and the confluence of personal computing and consumer electronics in the form of portable media players (PMPs), personal digital assistants (PDAs), sophisticated mobile phones, and laptop computers, all of which place a premium on compactness and reliability.

Nearly every personal computer and server in use today contains one or more hard disk drives (HDD) for permanently storing frequently accessed data. Every mainframe and supercomputer is connected to hundreds of HDDs. Consumer electronic goods ranging from camcorders to digital data recorders use HDDs. While HDDs store large amounts of data, HDDs consume a great deal of power, require long access times, and require “spin-up” time on power-up. Further, HDD technology based on magnetic recording technology is approaching a physical limitation due to super paramagnetic phenomenon. Data storage devices based on scanning probe microscopy (SPM) techniques have been studied as future ultra-high density (>1 Tbit/in²) systems. There is a need for techniques and structures to read and write to media that facilitate desirable data bit transfer rates and areal densities.

### BRIEF DESCRIPTION OF THE DRAWINGS

Further details of the present invention are explained with the help of the attached drawings in which:

FIG. 1 is a cross-sectional side view of an information storage device including a plurality of tips extending from corresponding cantilevers toward a movable media platform.

FIG. 2A is a plan view of a cantilever for use with systems such as shown in FIG. 1, the cantilever including a tip extending therefrom and pivotable about a fulcrum by electrostatic force.

FIG. 2B is a side-view of the cantilever of FIG. 2A with the tip arranged a median distance from the surface of the media.

FIG. 2C is a side-view of the cantilever of FIG. 2A actuated to position the tip in contact or near-contact with the media.

FIG. 3A is a side-view of the cantilever of FIG. 2A with the tip arranged an extreme distance away from the surface of the media, the cantilever actuated to position the tip in contact or near-contact with the media.

FIG. 3B is a side-view of the cantilever of FIG. 3A wherein the cantilever is actuated to position the tip at the same distance from the media as shown in FIG. 2C.

FIG. 3C is a side-view of the cantilever of FIG. 3A wherein pull-in of the proximal end to the bottom actuation electrode causes mechanical distortion of the torsion beam.

FIGS. 4A and 4B are plots of actuated tip contact force as a function of both actuation voltage and at-rest (i.e., non-actuated) tip-to-media distance for a cantilever such as shown in FIG. 2A-3C.

FIG. 5A is a plan view of an embodiment of a cantilever in accordance with the present invention for use with systems such as shown in FIG. 1.

FIG. 5B is a side-view of the cantilever of FIG. 5A with the tip arranged a median distance from the surface of the media.

FIG. 5C is a side-view of the cantilever of FIG. 5A with the tip arranged an extreme distance away from the surface of the media.

FIG. 5D is a side-view of the cantilever of FIG. 5A with the tip arranged an extreme distance away from the surface of the media, the cantilever actuated to position the tip in contact or near-contact with the media.

FIG. 6 is a plot of actuated tip contact force as a function of both actuation voltage and at-rest tip-to-media distance for a cantilever such as shown in FIGS. 5A-5D.

FIG. 7 is a side-view of an alternative embodiment of a cantilever in accordance with the present invention for use with systems such as shown in FIG. 1.

FIG. 8 is a side-view of a further embodiment of a cantilever in accordance with the present invention for use with systems such as shown in FIG. 1.

### DETAILED DESCRIPTION

Common reference numerals are used throughout the drawings and detailed description to indicate like elements; therefore, reference numerals used in a drawing may or may not be referenced in the detailed description specific to such drawing if the associated element is described elsewhere.

Systems for storing information (also referred to herein as information storage devices) enabling potentially higher density media storage relative to current ferromagnetic and solid state storage technology can include nanometer-scale heads, contact probe tips, non-contact probe tips, and the like capable of one or both of reading and writing to a media. High density information storage devices can include seek-and-scan probe (SSP) memory devices comprising cantilevers from which probe tips extend for communicating with a media using scanning-probe techniques. The cantilevers and probe tips can be implemented in a micro-electromechanical system (MEMS) and/or nano-electromechanical system (NEMS) device with a plurality of read-write channels working in parallel. Probe tips are hereinafter referred to as tips and can comprise structures that communicate with a media in one or more of contact, near contact, and non-contact mode. A tip need not be a protruding structure. For example, in some embodiments, a tip can comprise a cantilever or a portion of the cantilever.

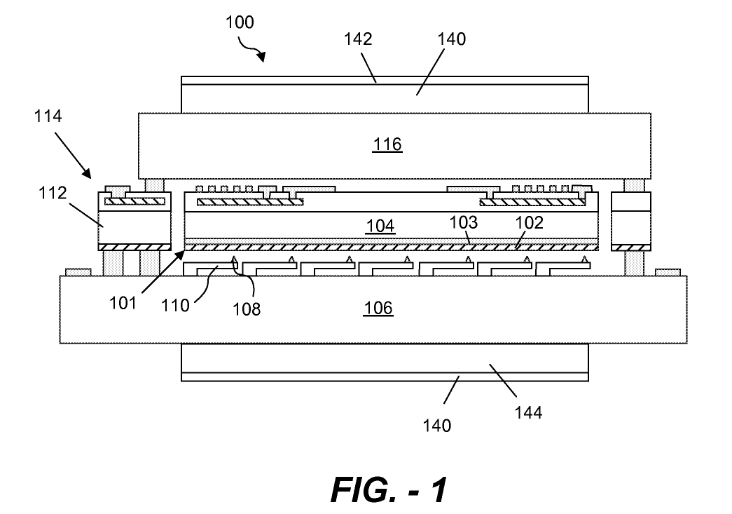

FIG. 1 is a simplified cross-sectional diagram of an information storage device 100 with which an embodiment of read and/or write structures in accordance with the present invention can be used. The information storage device 100 comprises a tip substrate 106 arranged substantially parallel to a media 101. Cantilevers 110 extend from the tip substrate 106 and tips 108 extend from respective cantilevers 110 toward the surface of a media 101. One or more of the tips 108 is connectable with the media 101 for forming, removing, manipulating and/or reading indicia in a recording layer 102 and/or on the surface of the media 101. The recording layer 102 can comprise a chalcogenide material, ferroelectric material, polymeric material, charge-trap material, or some other manipulable material known in probe-storage literature. Embodiments of read and/or write structures, systems including such structures, and methods of using such structures in accordance with the present invention can be applicable to multiple different recording layer materials and information storage techniques; however, the embodiments will be described hereinafter with particular reference to recording layers comprising ferroelectric materials.

As shown, the media 101 comprises a ferroelectric recording layer 102 including one or more layers of patterned and/or unpatterned ferroelectric films disposed over a conductive layer 103. The conductive layer 103 can be formed over a substrate or insulating layer. Information can be stored in the ferroelectric recording layer 102 as a spontaneous polarization either in a “+” (or “UP”) direction corresponding to one of “0” and “1,” or a “−” (or “DOWN”) direction, corresponding to the other of “0” and “1.” The ferroelectric recording layer 102 can achieve ultra high bit recording density because the thickness of a 180° domain wall in ferroelectric material is in the range of a few lattices (1-2 nm). The media 101 is associated with a platform 104. A media substrate 114 comprises the platform 104 and a frame 112, with the platform 104 suspended and movable within the frame 112 by a plurality of suspension structures (e.g., flexures—not shown). The tip substrate 106 is bonded to the frame 112 and the platform 104 (and by extension the media 101) is urged relative to the tip substrate 106. The platform 104 can be urged within the frame 112 by way of thermal actuators, piezoelectric actuators, voice coil motors 132, etc. The tip substrate 106 and a cap 116 can be bonded with the frame 112 on opposite surfaces of the frame 112 to seal the platform 104 within a cavity 120 between the cap 116 and tip substrate 106. Optionally, nitrogen or some other passivation gas can be introduced and sealed in the cavity 120. In other embodiments, the tip substrate 104 can be urged relative to the media 101 to allow the tips 108 to access the media 101. In still further embodiments, both the tip substrate 104 and media 101 can be urged to allow the tips 108 to access the media 101.

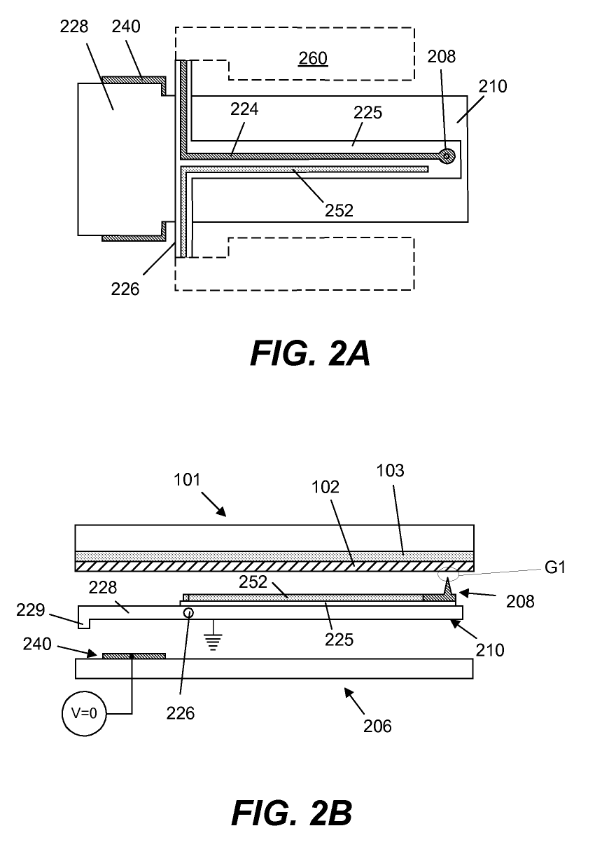

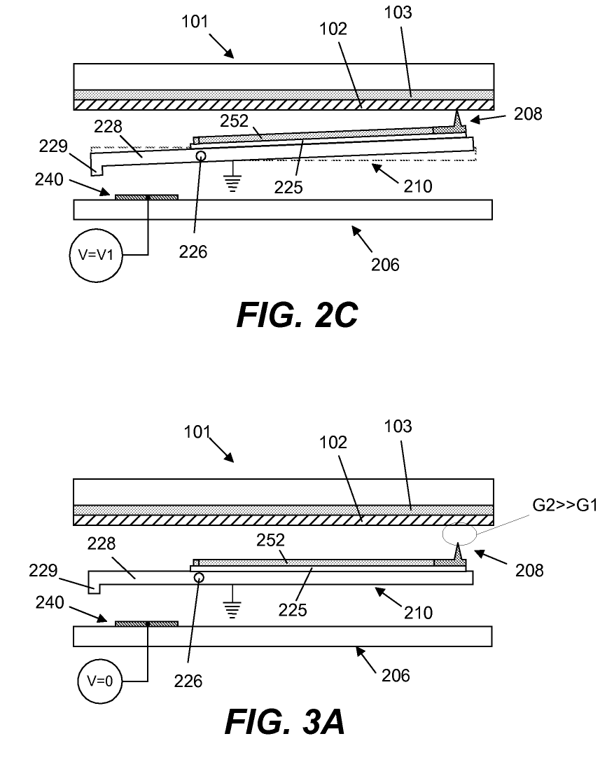

FIG. 2A is a plan view and FIG. 2B is a cross-sectional side-view of a cantilever 210 for use with information storage devices such as shown in FIG. 1. The cantilever 210 is connected and electrically grounded through a tip substrate 206 by way of a torsion beam 226 connected at both ends to beam anchors that can, optionally, be connected with a lateral actuation structure 262 (shown in phantom) for providing cross-track fine positioning control. One such lateral actuation structure usable with cantilevers in accordance with the present invention is described in U.S. Ser. No. ______ entitled “SSP CANTILEVER PROCESS WITH INTEGRATED VERTICAL AND LATERAL ACTUATION STRUCTURE,” by Chou and Heck, incorporated herein by reference. A tip 208 extends from the cantilever 210 toward the media 101 and is preferably connected with circuitry by a signal trace 224 electrically isolated from the grounded cantilever body by an insulating layer 225. Myriad different techniques can be applied to detect domain polarization of the ferroelectric recording layer. One such technique is described in U.S. Ser. No. 11/688,806 entitled “SYSTEMS AND METHODS OF WRITING AND READING A FERRO-ELECTRIC MEDIA WITH A PROBE TIP,” incorporated herein by reference. The technique comprises urging one of the media 101 and the tip 208 so that the tip passes along the surface of the media with electric charge coupling to the tip. The tip acts as an antenna and the charge coupled to the tip varies with polarization at a frequency determined by the rate of relative movement between the media 101 and the tip 208 and the length of the bit. The signal is amplified and data is extracted from the signal. As shown in FIG. 2A, in some embodiments the cantilever structure can also include a guard trace 252 and guard 250 for reducing interference from stray electric fields, thereby improving signal-to-noise ratio (SNR) for such techniques. The guard trace can be electrically isolated from the signal trace 224 by routing the guard trace 252 along one end of the torsion beam 226 and routing the signal trace 224 along the opposite end of the torsion beam 226.

A proximal end 228 of the cantilever 210 (on the left side of the torsion beam 226 in FIG. 2A) is arranged opposite a bottom actuation electrode 240 formed on the tip substrate 206. When not actuated, the tip 208 is separated from the media 101 by an air gap G1 (referred to hereinafter as a tip-to-media gap). Referring to FIG. 2C, the torsion beam 226 acts as a fulcrum and the cantilever 210 is rotated about the axis of the torsion beam 226 when a sufficiently high voltage potential V1 is applied to the bottom actuation electrode 240 causing electrostatic force to attract the proximal end 228 of the cantilever 210 to the bottom actuation electrode 240. As the cantilever 210 rotates about the torsion beam axis the tip 208 at the distal end of the cantilever 210 is urged toward the media 101 and can be placed in contact or near contact with the surface of the media 101. Electrostatic force is thereafter transferred to the tip/media interface as contact force by electrostatic torque about the axis of the torsion beam 226. A cantilever rotatable at a torsion beam (also referred to herein as a see-saw structure) can allow a tip to be selectively placed in contact or near-contact with a surface of a ferroelectric media. Such an arrangement can reduce wear on inactive tip(s) and/or associate selected tip(s) with read/write circuitry to reduce surface area dedicated to circuitry by way of shared traces and circuit components. It is noted that a lateral actuation structure (where present) connecting the cantilever 210 to the tip substrate 206 can enable cross-track fine positioning control for data track correction while the tip 208 is in contact with the media 101.

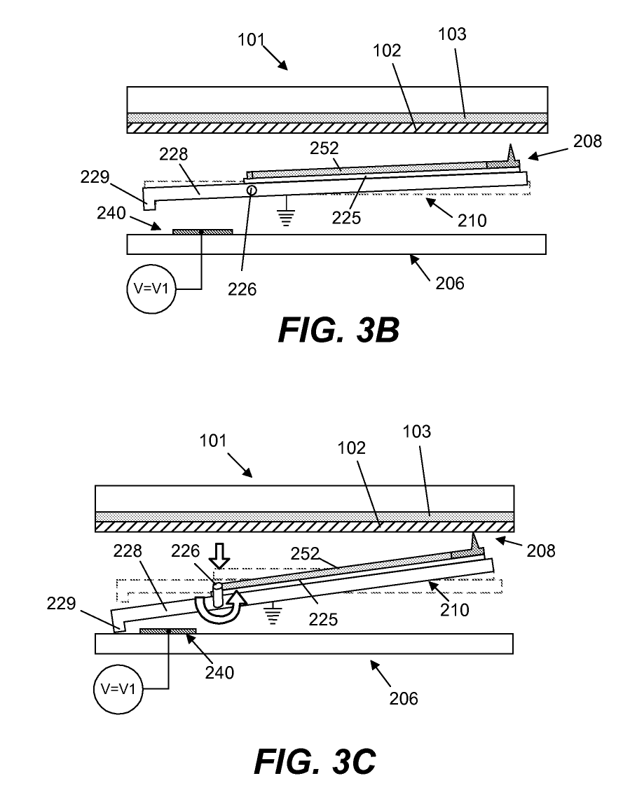

Referring again to FIGS. 2B and 2C, the tip substrate 206 is shown positioned a distance from the media 101 such that a tip-to-media gap is a median distance G1. As mentioned above, the tip substrate 206 is arranged substantially parallel to the media 101. However, the tip substrate 206 may not be perfectly parallel to the media 101. Spacing between the tip substrate 206 and the media 101 can vary for multiple different reasons, for example as a result of non-uniformity of one or both of the tip substrate and the media, or tilting of the platform due to differences in stiffness of the flexures. Further, even where spacing between the tip substrate 206 and the media 101 is exceptionally uniform, the tip-to-media gap or the proximal end-to-bottom actuation electrode distance can vary due to manufacturing variations or due to environmental changes. Referring to FIG. 3A, a tip substrate 206 is shown spaced from the media 101 a distance larger than the distance between the tip substrate 206 and media 101 of FIG. 2C so that the tip-to-media gap G2 is larger than the median tip-to-media gap G1. The cantilever 210 is rotated at the torsion beam 226 when a voltage potential V1 is applied to the bottom actuation electrode 240 causing electrostatic force to attract the proximal end 228 of the cantilever 210 to the bottom actuation electrode 240. As shown in FIG. 3B, the tip-to-media gap G2 is overly large such that the electrostatic force is not transferred to the tip/media interface when the cantilever is rotated an amount as shown in FIG. 2C. The cantilever 208 continues to rotate at the torsion beam and the proximal end 228 is urged closer to the bottom actuation electrode. Electrostatic force between two surfaces varies inversely with the square of the gap between the two surfaces; that is, the electrostatic force increases quadratically with the reduction in the gap between the proximal end 228 and the bottom actuation electrode 240. Referring to FIG. 3C, as a gap between the proximal end and the bottom actuation electrode becomes smaller, the cantilever 210 is subjected to an increasing electrostatic torque about the axis of the torsion beam 226, potentially causing the tip 208 to be urged against the media 101 with undesirably large contact force. The undesirably large contact force can cause damage to one or both of the media 101 and the tip 208. Damage can include tip wear that can reduce the useable life of the tip and/or pitting of the media surface that can contribute to read/write errors and tip wear.

The cantilever 210 can be drawn toward the bottom actuation electrode 240 with increasing force until a pull-in contact stop 229 of the proximal end 228 contacts the tip substrate 206 (to the left of the bottom actuation electrode 240). A threshold limit may be exceeded and the electrostatic torque may overwhelm the restoring torque due to torsion stiffniess of the torsion beam 226 so that the torsion beam 226 becomes mechanically distorted via flexure of the torsion beams 226 toward the tip substrate 206. As shown in FIG. 3C, the torsion beam 226 can bend along the axis of rotation. The threshold of electrostatic force sufficient to cause the pull-in contact stop 229 of the proximal end 228 to contact the bottom actuation electrode 240 and/or the threshold of electrostatic force sufficient to cause mechanical distortion of the torsion beam 226 is referred to hereinafter as “pull-in.” Pull-in can occur even though the tip-to-media gap is within an intended operational range for a first applied voltage if a second, higher applied voltage is applied to the bottom actuation electrode. A range of applied voltages and tip-to-media gaps, the combination of which results in pull-in is referred to hereinafter as a pull-in regime. When pull-in has occurred, the tip may make contact with the media with a contact force that is within an acceptable range; however, because the cantilever is in contact with the tip substrate, it is undesirable to use the lateral actuation structure to reposition the cantilever laterally for fine data track correction. Repositioning may be resisted by the proximal end, or repositioning may undesirably drag the proximal end along the tip substrate. As a result, the pull-in regime is not usable for cantilever data read/write even if adequate tip-to-media contact force can be realized.

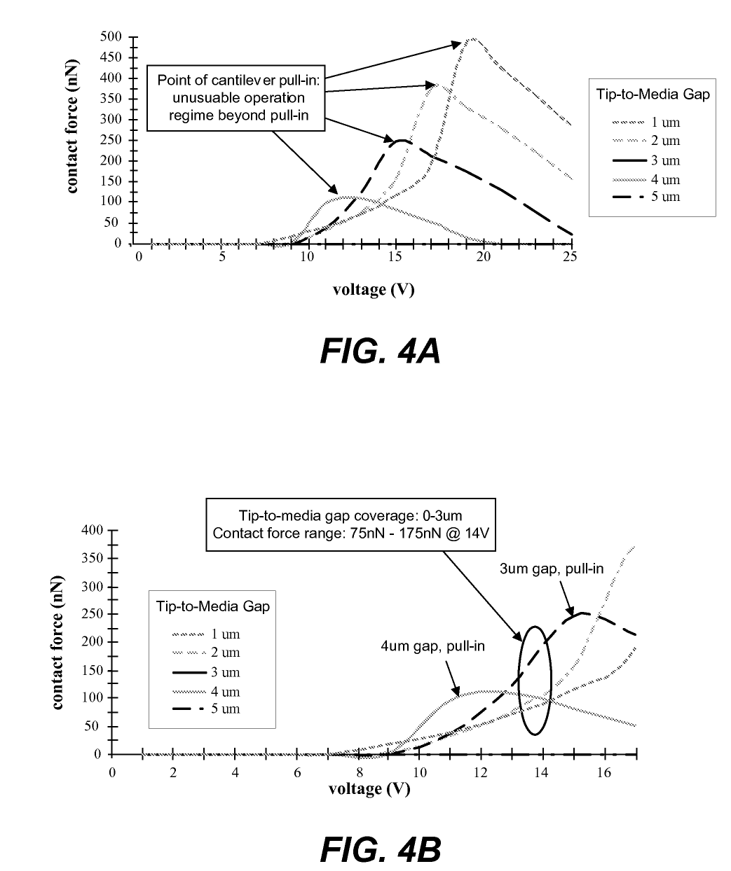

FIG. 4A is a plot from a simulation of a cantilever and tip as described in FIGS. 2A-3C illustrating contact force as a function of voltage for cantilevers having tip-to-media gaps ranging from 1 μm to 5 μm. Note that the curve for a tip-to-media gap of 5 um is coincident with the abscissa since for a tip-to-media gap this large tip-to-media contact does not occur for any voltage, hence the contact force is zero throughout. As can be seen, contact force applied by the tip to the media increases as voltage increases. The increasing electrostatic force between the bottom actuation electrode and proximal end causes the moment force at the torsion beam to increase and the tip to be urged against the media with increasing force. As pull-in occurs, the contact force peaks, then tapers off as the torsion beam undergoes flexure and the entire cantilever, along with the tip, is drawn toward the bottom actuation electrode and tip substrate. FIG. 4B is a plot showing a portion of the data displayed in FIG. 4A to better illustrate cantilever/tip performance at a voltage of 14 volts. As can be seen, tips initially separated from the media by 4 μm or greater fall into the unusable pull-in regime for a voltage of 14 volts. Thus, a practical tip-to-media gap coverage (qualifying a range of usable cantilever/tips) can be defined as 0 μm to about 3 μm (the exact usable gap likely falls some fractional distance between 3 μm and 4 μm for the cantilever/tips measured; however, manufacturing variation and environmental changes suggest defining a tip-to-media gap range comfortably within a performance range). In this particular embodiment, the contact force range applied by tips for which the initial tip-to-media gap is 0-3 μm extends from 75 nN to 175 nN.

Advantage can be gained by further extending the practical tip-to-media gap coverage beyond 3 μm, so that the coverage is as broad as is practicable given the operating specifications of the device. Broadening tip-to-media gap coverage can allow information storage devices to be manufactured that are more forgiving of environmental changes during device operation, providing increased robustness in performance. Further, fabrication tolerances can be relaxed to allow more process non-uniformity, thereby potentially increasing fabrication yield. Embodiments of cantilevers and tip structures for use in information storage devices and methods of actuating cantilever in information storage devices in accordance with the present invention can be applied to broaden a tip-to-media gap coverage.

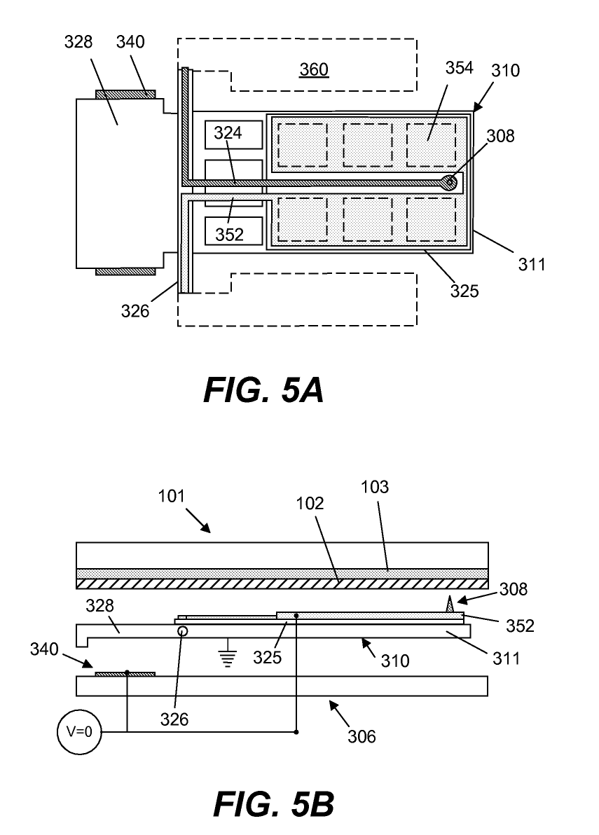

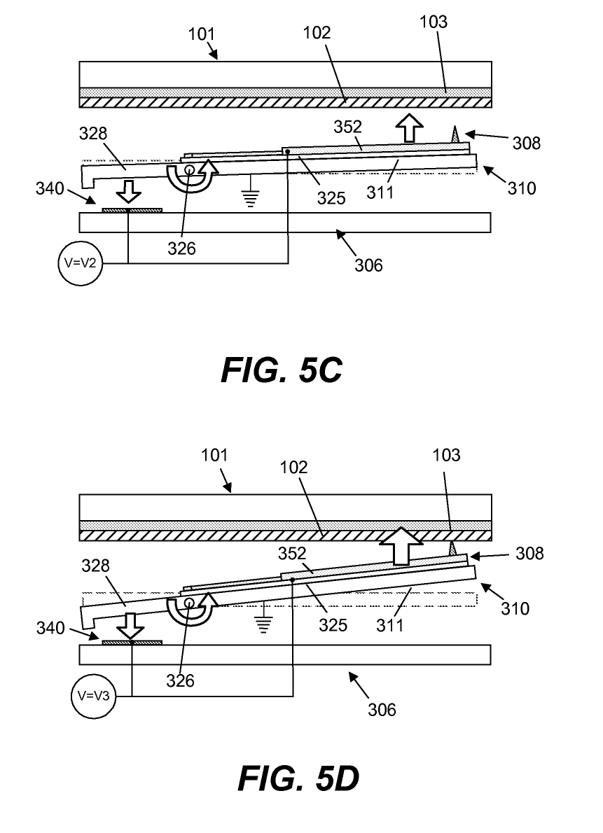

Referring to FIGS. 5A-5D, an embodiment of a cantilever 310 and tip 308 structure for use in information storage devices in accordance with the present invention is illustrated. The cantilever 310 comprises a top actuation electrode 352 formed on a portion of the surface of the cantilever 310 that opposes the media 101 and that is positioned on an opposite side of the torsion beam 326 from the bottom actuation electrode 340 of the tip substrate 306. A voltage potential applied between the top actuation electrode 352 and the conductive layer 103 can generate an electrostatic force to increase the moment force at the torsion beam 326. A voltage source can be electrically connected with the top actuation electrode 352 or alternatively with the conductive layer 103. Because the cantilever relies on electrostatic force generated at two electrodes (the bottom actuation electrode of the tip substrate and the top actuation electrode), the cantilever is referred to herein as a dual-electrode, or dual-actuation, see-saw structure. In operation, a relatively small actuation voltage V2 is applied, and an electrostatic force generated by the bottom actuation electrode 340 will attract the proximal end 328 of the cantilever 310 (i.e., the left side cantilever beam as shown in FIG. 5B-5D) to the bottom actuation electrode 340. An electrostatic force generated at the top actuation electrode 352 will attract the top actuation electrode 352 (and by extension the tip 308) towards the media 101 surface. The electrostatic torques generated by both the bottom and top actuation electrodes 340,352 rotate the cantilever 310 at the torsion beam 326 additively until moment equilibrium is achieved. Referring to FIG. 5C, when there is a relatively large tip-to-media-gap, the bottom actuation electrode 340 generates the primary force to rotate the cantilever 310 until the electrostatic force generated by the top actuation electrode 352 becomes significant as the tip-to-media gap—i.e., the electrostatic gap for the top actuation electrode—is reduced. The top actuation electrode 352 can contribute appreciable electrostatic force; therefore, a lower voltage is needed to rotate the cantilever 310 and bring the tip 308 in contact or near-contact with the media 101 relative to the single-electrode see-saw structure of FIGS. 2A-3C, Contact force of the tip 308 to the media 101 is predominately exerted by electrostatic force between the top actuation electrode 352 and the conductive layer 103 when the cantilever 310 is rotated to a position where the tip 308 contacts the media 101. A gap defined by the tip height separates the top actuation electrode 352 and the surface of the media. The gap is very small; therefore a relatively high contact force between the tip 308 and the media 101 can be achieved by applying a second voltage V3 to the bottom and top actuation electrodes 340,352 larger than the actuation voltage V2 but smaller than the actuation voltage of the single-electrode see-saw structure of FIGS. 2A-3C. A relatively low actuation voltage of the dual-electrode see-saw structure reduces an actuation force applied to the torsion beam and can substantially reduce an opportunity for pull-in. Still further, the actuation force between the top actuation electrode 352 and the conductive layer 103 acts to at least partially counter the actuation force between the bottom actuation electrode 340 and the proximal end 328, so that the possibility of mechanical flexure of the torsion beam 326 is substantially reduced.

Tip-to-media gap coverage can be extended, and tip contact force can be increased with reduced voltage during read/write operations. The top actuation electrode 352 is insulated from the cantilever body 311 by a dielectric layer 325 and connected to a voltage source common to the top and bottom actuation electrodes by way of an electrical trace 352 that extends along one side of the torsion beam 326. In order to reduce the parasitic capacitance between top actuation electrode 352 and cantilever body 311, the top actuation electrode 352 can be partially suspended over gaps in the cantilever body 311 as a membrane electrode (shown as dashed boxes in FIG. 4A).

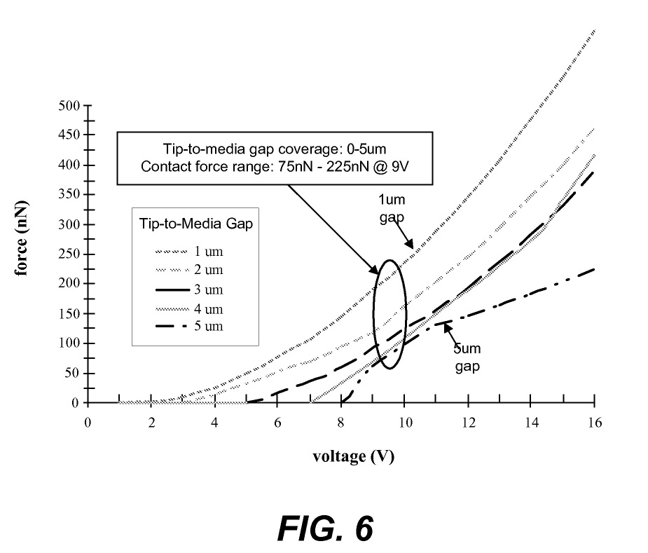

FIG. 6 is a plot from a simulation of a cantilever and tip having a dual-electrode see-saw structure illustrating contact force as a function of voltage for cantilevers as described in FIGS. 5A-5D having tip-to-media gaps ranging from 1 μm to 5 μm. The increasing electrostatic force between the bottom actuation electrode and proximal end and the top actuation electrode and the conductive layer of the media causes the moment force at the torsion beam to increase and the tip to be urged against the media with increasing force. As can be seen, contact force applied by the tip to the media increases as voltage increases. In contrast to the plots of FIGS. 4A and 4B showing contact force as a function of voltage and tip-to-media gap for the single electrode see-saw structure, mechanical flexure of the torsion beam does not occur, and is not reflected by tapering off of the contact force that identifies the pull-in regime in the plots of FIGS. 4A and 4B. FIG. 6 illustrates cantilever/tip performance at a voltage of 9 volts. As can be seen, none of the tips initially separated from the media by a tip-to-media gap within the plotted range of 1 μm to 5 μm fall into an unusable pull-in regime. Thus, a practical tip-to-media gap coverage (qualifying a range of usable cantilever/tips) can be defined as 0 μm to at least 5 μm. The range of contact force applied by a tip to the media within the tip-to-media gap of 0-5 μm extends from 75 nN to 225 nN.

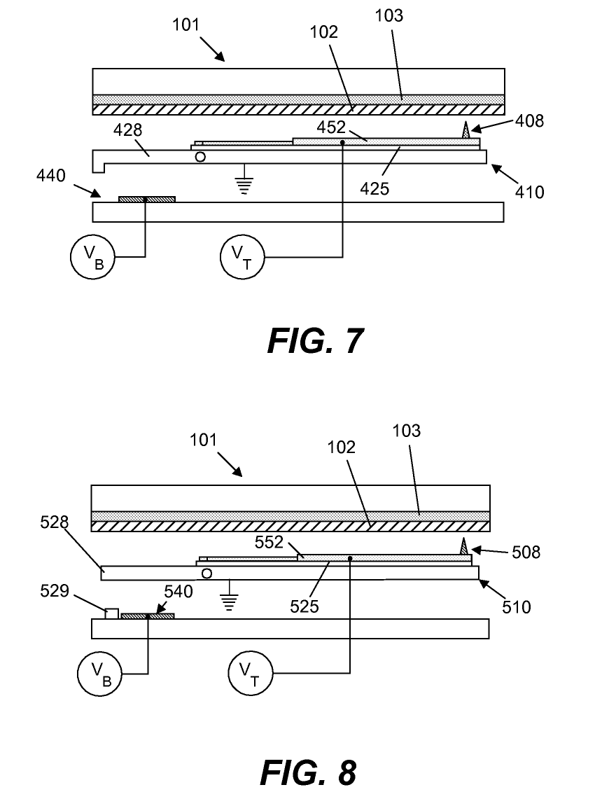

Referring to FIG. 7, an alternative embodiment of a cantilever 410 and tip 408 structure for use in information storage devices in accordance with the present invention is illustrated. The cantilever 410 and tip 408 structure resembles the dual-electrode see-saw structure of FIGS. 5A-5D; however, the bottom actuation electrode 440 and top actuation electrode 452 are coupled to separate voltage sources V_{B},V_{T}. Electrically separating the bottom actuation electrode 440 and top actuation electrode 452 can enable independent application of voltage potential. For example, in some embodiments the actuation voltage applied to V_{B} can vary over time, so that a relatively large voltage is reduced as the proximal end 428 approaches the bottom actuation electrode 440. In still further embodiments independent application of voltage potential can enable use of the top actuation electrode 452 for determining polarization of the domains within the ferroelectric layer. An alternative technique for detecting domain polarization using a conductive structure referred to as a B-plate is described in U.S. Ser. No. 12/030,101 entitled “METHOD AND DEVICE FOR DETECTING FERROELECTRIC POLARIZATION,” incorporated herein by reference. The technique relies, in an embodiment described therein, on applying a probe voltage (or current) across the ferroelectric recording layer and vibrating the cantilever to vary the capacitance of the B-plate. The varying capacitance modulates a carrier signal applied to the B-plate, the modulated carrier signal being electrically isolated (disregarding parasitic capacitances) from the probe voltage. A domain polarization can be determined based on the modulation of the carrier signal. Cantilever 410 and tip 408 structures in accordance with the present invention can be used to enable broader tip-to-media gap coverage and also to enable techniques for determining polarization using a conductive structure communicating a carrier signal. For example, the cantilever of FIG. 7 can be rotated by applying a first actuation voltage V_{B} to the bottom actuation electrode 440 and a second actuation voltage V_{T} to the top actuation electrode 452. A carrier signal can further be applied to the top actuation signal for modulation by the varying capacitance when a probe voltage is applied to the tip 408.

In still further embodiments, independent application of voltage potential can enable use of the top actuation electrode 452 to “pump” the tip 408 so that contact force between the tip 408 and media 101 surface varies over time. As described in U.S. Ser. No. 61/089,276 entitled “METHOD AND DEVICE FOR DETECTING FERROELECTRIC POLARIZATION” by Donald Adams (NANO-01104US0), pumping the tip can reduce tip wear by reducing stick-slip caused by the surfaces of the tip and media alternatingly sticking to each other and sliding over each other with a corresponding change in the force of friction. Cantilever 410 and tip 408 structures in accordance with the present invention can be used to enable broader tip-to-media gap coverage and also to enable techniques to reduce tip 408 wear by applying a time-varying signal to the top actuation electrode. For example, the cantilever of FIG. 7 can be rotated by applying a first actuation voltage V_{B} to the bottom actuation electrode 440 and a second actuation voltage V_{T} to the top actuation electrode 452. A time-varying signal can then be applied to vary the amount of contact force applied by the tip 408 to the media 101. Optionally, the time-varying signal applied to the top actuation electrode 452 can further enable detection of an upper band signal associated with a charge coupled to the tip 408 whose phase is determined by the polarization of the ferroelectric recording layer 102.

Referring to FIG. 8, an alternative embodiment of a cantilever 510 and tip 508 structure for use in information storage devices in accordance with the present invention is illustrated. The cantilever 510 and tip 508 structure resembles the dual-electrode see-saw structure of FIG. 7; however, a pull-in contact stop structure 529 is formed on the tip substrate 506 and located beyond the bottom actuation electrode 540. The proximal end 528 of the cantilever 510 contacts the pull-in contact stop 529 when electrostatic force between the proximal end 528 and bottom actuation electrode 540 exceed the pull-in threshold. As in FIG. 7, the bottom actuation electrode 540 and a top actuation electrode 552 coupled to separate voltage sources V_{B},V_{T}; however, in still further embodiments the bottom actuation electrode 540 and the top actuation electrode 552 can be coupled to a common voltage source.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. An information storage device comprising:
a media including a ferroelectric layer and a conductive layer;
a tip substrate including a bottom actuation electrode, the tip substrate arranged opposite the media;
a cantilever connected with the tip substrate at a fulcrum and actuatable toward the media including:
a first portion and a second portion,
wherein the fulcrum is located between the first portion and the second portion,
wherein the first portion is conductive and arranged over the bottom actuation electrode,
a tip extending from the second portion toward the media, and
a top actuation electrode associated with the second portion so that the top actuation electrode is opposite the media;
circuitry to apply a first potential between the bottom actuation electrode and the first portion to generate electrostatic force between the bottom actuation electrode and the first portion; and
circuitry to apply a second potential between the top actuation electrode and the conductive layer to generate electrostatic force between the top actuation electrode and the conductive layer; and
wherein the cantilever rotates when the first potential and the second potential are applied so that the tip contacts the media.

2. The information storage device of claim 1 wherein:
the first potential and the second potential are equal; and
the first potential and the second potential are applied by a common source.

3. The information storage device of claim 2 wherein the common source is electrically connected with one of the bottom actuation electrode and the first portion and one of the top actuation electrode and the conductive layer.

4. The information storage device of claim 1 wherein the first potential is applied by a first source and the second potential is applied by a second source.

5. The information storage device of claim 4 wherein the first source is electrically connected with one of the bottom actuation electrode and the first portion and the second source is electrically connected with one of the top actuation electrode and the conductive layer.

6. The information storage device of claim 1 wherein the fulcrum is a torsion beam.

7. The information storage device of claim 1 wherein the cantilever further includes an insulating material between the top actuation electrode and the second portion.

8. The information storage device of claim 1 wherein:
the second portion includes a frame to support the top actuation electrode; and
the top actuation electrode is suspended over gaps in the frame;
the gaps reduce a parasitic capacitance formed between the top actuation electrode and the second portion.

9. The information storage device of claim 4 wherein the second source can apply a carrier signal to the top actuation electrode, the carrier signal being modulated by a polarization of the ferroelectric layer.

10. The information storage device of claim 4 wherein the second source can apply a pumping signal to the top actuation electrode so that a contact force between the tip and the media varies with time.

11. An information storage device comprising:
a media including a recording layer and a conductive layer;
a tip substrate including a bottom actuation electrode and arranged opposite the media;
a cantilever including:
a first portion and a second portion;
a fulcrum arranged between the first portion and the second portion;
a conductive structure associated with the first portion and arranged opposite the bottom actuation electrode;
a tip extending from the second portion toward the media, and
a top actuation electrode associated with the second portion;
wherein when a first potential is applied to the bottom actuation electrode, an electrostatic force is generated between the bottom actuation electrode and the first portion; and
wherein when a second potential is applied the top actuation electrode, an electrostatic force is generated between the top actuation electrode and the conductive layer.

12. The information storage device of claim 11 wherein the cantilever rotates when the first potential and the second potential are applied so that the tip contacts the media.

13. The information storage device of claim 12 wherein:
the first potential and the second potential are equal; and
the first potential and the second potential are applied by a common source.

14. The information storage device of claim 13 wherein the common source is electrically connected with one of the bottom actuation electrode and the first portion and one of the top actuation electrode and the conductive layer.

15. The information storage device of claim 12 wherein the first potential is applied by a first source and the second potential is applied by a second source.

16. The information storage device of claim 15 wherein the first source is electrically connected with one of the bottom actuation electrode and the first portion and the second source is electrically connected with one of the top actuation electrode and the conductive layer.

17. The information storage device of claim 11 wherein the fulcrum is a torsion beam.

18. The information storage device of claim 11 wherein:
the second portion comprises a frame to support the top actuation electrode; and
the top actuation electrode is suspended over gaps in the frame;
the gaps reduce a parasitic capacitance formed between the top actuation electrode and the second portion.

19. The information storage device of claim 15 wherein the second source can apply a carrier signal to the top actuation electrode, the carrier signal being modulated by a polarization of the ferroelectric layer.

20. The information storage device of claim 15 wherein the second source can apply a pumping signal to the top actuation electrode so that a contact force between the tip and the media varies with time.

21. An information storage device comprising:
a media including a recording layer and a bottom media electrode;
a tip substrate arranged opposite the media;
a cantilever having a see-saw structure with a first portion and a second portion and a tip extending from the second portion;
a bottom actuation electrode associated with the first portion;
a top actuation electrode coupled with the second portion and electrically isolated from the tip;
wherein when a first potential is applied to the bottom actuation electrode, an electrostatic force is generated that urges the first portion toward the tip substrate; and
wherein when a second potential is applied the top actuation electrode, an electrostatic force is generated between the top actuation electrode and the bottom media electrode.

22. The information storage device of claim 21 wherein the cantilever rotates when the first potential and the second potential are applied so that the tip contacts the media.

23. The information storage device of claim 22 wherein:
the first potential and the second potential are equal; and
the first potential and the second potential are applied by a common source.

24. The information storage device of claim 23 wherein the common source is electrically connected with one of the bottom actuation electrode and the first portion and one of the top actuation electrode and the conductive layer.

25. The information storage device of claim 22 wherein the first potential is applied by a first source and the second potential is applied by a second source.

26. The information storage device of claim 23 wherein the first source is electrically connected with one of the bottom actuation electrode and the first portion and the second source is electrically connected with one of the top actuation electrode and the conductive layer.
